(19) United States
(12) Patent Application Publication
(10) Pub. No.: US 2006/0276247 A1
(43) Pub. Date: Dec. 7, 2006

(54) Flexible shaft

(76) Inventor: Jaime E. Martinez, Pompton Plains, NJ (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 11/144,148

(22) Filed: Jun. 3, 2005

(51) Int. Cl. F16D 3/52

(52) U.S. Cl. 464/78

(57) ABSTRACT

A flexible shaft or member can transfer rotating motion from one external end to another without any appreciable loss of torque movement and which can have various uses, including providing a flexible support between adjacent components to provide a flexible support therebetween. The flexible shaft is constructed of a body having pairs of specially designed slots formed in the peripheral surface thereof. The slots are formed in pairs of oppositely disposed slots having elongated openings in the peripheral surface that are in a common plane. Each slot of a pair extends inwardly toward the other slot of that pair but all slots terminate short of the midpoint of the body, thereby leaving web sections therebetween. Each successive pair of slots is angularly displaced with respect to the preceding pair of slots, preferably about 90 degrees about the peripheral surface of the body, thereby forming a flexible portion of the body.

### FIELD OF THE INVENTION

The present invention relates generally to shafts and, more particularly, to a flexible shaft having the ability to transmit rotary motion between the ends of the flexible shaft with minimal loss of axial torque and to provide a flexible member for alternate uses.

### BACKGROUND OF THE INVENTION

In the field of devices that are used to transmit rotary motion, there are certain of such devices that are shafts that can be connected to a rotary motion generating apparatus and the purpose of the shaft is to transmit that rotary motion from one end of the shaft that is connected to the device creating the rotary motion to the other end for some end use purpose. There are a number of uses for such shafts and one category of such uses mandates that the shaft not only transmit the rotary motion efficiently, that is, without loss of torque, but also to have a certain degree of flexible to the shaft. There are also other uses for a flexible member that utilize the flexing of that member for various purposes other than the transmission of rotary movement, that is, where the flexibility of the shaft itself is used to provide a flexible support between two points that can thus have relative motion between those points that is determined by the designed flexibility of the shaft or member.

Thus, the shafts or members for such uses have a flexibility that is built in by the manufacturer of the shaft to have sufficient flexibility to meet the particular needs for the use of the shaft. Typical uses of flexible shafts include bone drills, reamers, bone plug introducers and the like as well as devices to provide a flexible support between two components or points and it is, therefore, important that the manufacturer be able to provide the flexible shaft having the predetermined degree of bending and flexibility but also be able to produce differing shafts with the flexibility that is designed into the shaft or member by the manufacturer.

There is, therefore a need for a shaft that is flexible while transferring the true torque or rotational power for the aforedescribed uses or other uses and also a need for a flexible member having a flexibility determined by the design and manufacture of the member and which can be used for a variety of purposes, including a flexible support that joins or spans between two components that are thus allowed to move with respect to each other.

One example of a flexible shaft is shown and described in U.S. Pat. No. 5,488,761 of Leone where the shaft has one or more helical slots that extend from the distal end to the proximal end of the shaft. In the construction of the Leone shaft, the helical slot is cut into the shaft while that shaft is being rotated while, at the same time, the shaft is linearly advancing in order to form the helical shaped slots in the shaft. One drawback, however, of the Leone flexible shaft is that the shaft acts like a coiled spring and therefore there is a loss of motion or torsional movement as the shaft is twisted. As such, in either direction of rotation, the Leone shaft will either tend to coil tighter or uncoil as the rotational motion is transmitted between the proximal and distal ends. There is, therefore, a loss of motion as that torsional motion is transmitted along the length of the Leone flexible shaft.

Accordingly it would be advantageous to provide a flexible shaft that can transmit the rotational power along the shaft while minimizing the loss of rotational motion that can be used for the above purposes and yet that can be relatively easily manufactured to exhibit the desired flexibility characteristics for the particular end use. It would also be advantageous to have a flexible member that can be manufactured so as to have a desired flexibility for uses other than simply transmitting rotary motion.

### SUMMARY OF THE INVENTION

The present invention relates to a flexible shaft for use as a coupling to transmit rotational power from one end to the other end and which is relatively easy to produce and minimizes lost torque due to twisting of the shaft. Another use of the present flexible member is to provide the ability to utilize a rigid tubular piece of metal or other material and convert the member into a flexible member having a designed in flexibility.

In the construction of the present flexible shaft, there is a body, preferably tubular, that has external ends for transmitting the rotational motion from one end to the other. In general, the proximal end will be referred to as the end that is connected to some apparatus that provides the rotational motion and the flexible shaft thereby transmits that rotational motion to the distal end of the flexible shaft for some end use.

The tubular body has a longitudinal axis and an outer peripheral surface. There are a plurality of pairs of slots formed in the outer peripheral surface of the tubular body and each pair of slots comprises oppositely disposed slots spaced apart at an angle around the peripheral surface. Each slot of a pair of slots is formed by an opening in the outer peripheral surface of the tubular body and the openings are elongated openings that are formed in a common plane that is orthogonal to the longitudinal axis of the body, that is, each pair of elongated openings in the outer peripheral surface is in the same lateral plane.

The slots themselves thereafter extend inwardly toward the center of the tubular body and those slots may also be located in the same plane or be formed at a slight angle with respect to that plane. Thus, whereas the elongated openings of each pair of opposite slots is co-planar, the actual slots themselves may be co-planar or may be formed at an angle with respect to the plane passing through the elongated openings in the outer peripheral surface of the tubular body. The slots may be of differing configuration, including inwardly tapering slots.

The slots may be formed of a number of differing methods, one being by means of electrical discharge machining (EDM), however, other machining means can be utilized including milling the slots into the tubular body.

Each pair of slots includes two oppositely formed slots that are non-continuous, that is, the use of opposite pairs of slots creates the formation of web sections between each pair of slots and the pairs of slots do not fully encircle the tubular body. Further, in each of the pairs of slots, the depth of the slots into the tubular body does not extend to the center of the tubular body but terminate short of that center or longitudinal axis of the tubular body in order to assure the formation of the web sections between each pair of slots. There are, therefore, at least two web sections that separate the terminal ends of each of the elongated openings in the tubular body.

In the design and manufacture of the flexible shaft of the present invention, therefore, as will be later become clear, the flexible shaft can readily be constructed so as to have the flexibility that is desired by the manufacturer for the particular need. The flexibility of a shaft constructed in accordance with the present invention can be varied in accordance with a predetermined design by varying certain dimensions and/or parameters of the flexible shaft. For example, the width of the slots can be controlled to vary the ultimate flexibility; the depth of the slots can be varied (varying the width of the web sections), and the angle of the slots can be controlled to affect the flexibility of the flexible shaft.

As such, if the opposite slots are formed at the maximum depth, thereby forming very thin web sections, there is a greater flexibility to the flexible shaft than where the oppositely disposed slots are only formed partially into the tubular body and relatively larger web sections are left. Thus, in designing the degree of flexibility of the flexible shaft, the depth of the oppositely disposed slots are determined in order to arrive at the particular desired flexibility.

Similarly, the greater the width of the slots the more flexible the final flexible shaft so that the manufacturer of the flexible shaft can utilize the design and manufacturing process itself to construct a flexible shaft having the customized degree of flexibility needed for the ultimate use of the flexible shaft. As can also be understood, the longitudinal spacing between the successive slots can also vary the flexibility of the flexible shaft, that is the closer the pairs of slots are together along the longitudinal axis of the flexible shaft, the more flexible the shaft will be.

Another determinant of the degree of flexibility is, of course, the material that is used in constructing the flexible shaft. That material may be one of a wide variety of materials including, but not limited to stainless steel, titanium based or other steels as well as plastic or composite materials. The more flexible the material used in the construction of the flexible shaft, the more flexibility is built into the overall flexible shaft itself in its finished form.

The location of the pairs of slots are such that each pair is angularly displaced with respect to its adjacent pair of slots, that is, each successive pair of slots is angularly rotated with respect to the previous set of slots. In one disclosed embodiment, that angle of displacement is about 90 degrees such that each successive pair of slots is oriented a quarter of a turn around the flexible shaft with respect to the preceding pair of slots, however, the angular displacement of the successive pairs of slots can vary in accordance with the desired flexibility of the flexible shaft.

With the present invention it can also be seen that the degree of flexibility can vary, as desired, along the longitudinal axis or linear length of the flexible shaft. As such, by varying the width of the slots or spacing between the slots, or one of the previously mentioned dimensional or parameters affecting the flexibility of the shaft, differing degrees of flexibility can be provided at different locations along the length of the flexible shaft such that one section of shaft may be very flexible while another section along the same shaft may be designed to have less flexibility. The control of the flexure of the shaft of the present invention enables the shaft or member to be designed and manufactured for other uses, among those uses is in constructing a member that can provide a sturdy, yet flexible connection between components to provide a flexible support therebetween.

These and other features and advantages of the present invention will become more readily apparent during the following detailed description taken in conjunction with the drawings herein.

### BRIEF DESCRIPTION OF THE DRAWINGS

FIG. 1 is a side view of an exemplary flexible shaft of the present invention;

FIG. 2 is an enlarged view of a portion of the flexible shaft of FIG. 1;

FIG. 3 is side cross-sectional view of a portion of the flexible shaft of FIG. 2 taken along the line 3-3 of FIG. 2;

FIG. 4 is a side view of the flexible shaft of FIG. 1 in a flexed orientation;

FI G. 5 is a side, cross sectional view of the flexible shaft of the present invention having slots that are formed with an inward taper; and

FIG. 6 is a side view of a flexible shaft of the present invention having the slots alternatively radially spaced apart.

### DETAILED DESCRIPTION OF THE INVENTION

Referring now to FIG. 1, there is shown a perspective view of an exemplary flexible shaft 10 constructed in accordance with the present invention. As can be seen, the flexible shaft 10 comprises a tubular body 12 having external ends 14, 16 and a cylindrical peripheral outer surface 17. The external ends 14, 16 may have various configurations of connecting profiles and shapes to enable the flexible shaft 10 to be readily connectible to a source of rotational movement at a proximal end and to a transmit that rotational movement to some end use at the opposite or distal end of the tubular body 12. A longitudinal axis A extends along the center of the tubular body 12 through the external ends 14, 16.

As also can be seen in FIG. 1, there is a flexible portion 18 of the flexible shaft 10 and which allows the tubular body 12 to flex with respect to the opposite external ends 14, 16 in the use thereof. The linear length of the flexible portion 18 may vary according to the use and desired flexibility of the flexible shaft 10. In one embodiment, the tubular body 12 is constructed of stainless steel, however, other relatively rigid materials could be used consistent with the intent and purpose of the present invention. Such other materials can include, but are not limited to, titanium based steels, plastic or composite materials.

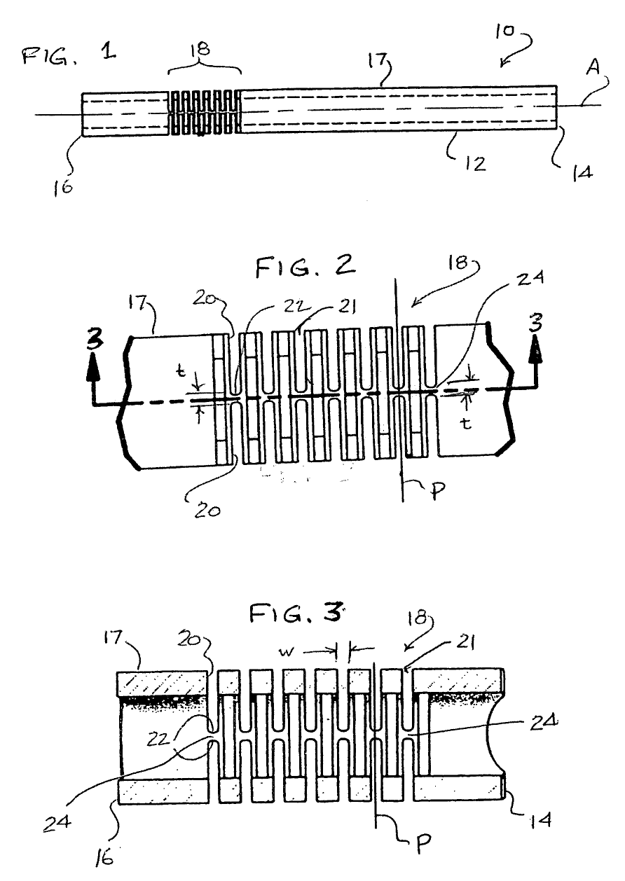

Turning now to FIG. 2, there is shown an enlarged side view illustrating the flexible portion 18 of the flexible shaft 10. As such, there are a plurality of pairs of oppositely disposed slots 20 formed in the tubular body 12 and, as shown, those slots 20 are specially located and configured so as to create the desirable features of the present invention. The slots 20 are each comprised of an elongated opening 21 that is located along the peripheral outer surface 17 of the tubular body 12 and extend inwardly toward the longitudinal axis A of the flexible shaft 10. The elongated openings 21 of each pair of oppositely disposed slots 20 are located in a common plane, illustrated as P in FIG. 2, that is at a right angle or 90 degrees to the longitudinal axis A with the elongated openings 21 of each pair formed in the same plane orthogonal to the longitudinal axis A. As can be seen in FIG. 2, the pairs of slots 20 are illustrated to extend inwardly such that each slot of a pair of slots 20 lies along the same plane P as the elongated openings 21, however, as will be seen, the slots 20 may be angled with respect to that plane such that while the elongated openings 21 of each pair of slots may be along the same lateral plane, the slots 20 themselves may be directed inwardly at an angle with respect to that plane.

The slots 20 are formed in the outer peripheral surface 17 of the tubular body 12 such that each slot 20 is less than 180 degrees about the peripheral outer surface 17 of the tubular body 12. Accordingly, since the pairs of slots 20 each are grouped in oppositely disposed slots 20, each slot is cut into the tubular body 12 and the slots 20 approach each other but terminate at ends 22 short of reaching the center of the tubular body 12, that is, the pairs of slots 20 are non-continuous and do not reach the longitudinal axis A as shown in FIG. 1.

Therefore, between each of the ends 22 of a pair of slots 20 there are formed web sections 24 that separate the ends 22 of the pairs of slots 20. Thus, each pair of oppositely disposed slots 20 as illustrated in FIG. 2 are in a common plane with the web sections 24 separating the ends 22 of each pair of slots that are formed in the tubular body 12 to approach each other but fall short of reaching the midpoint or longitudinal axis A of the tubular body 12. As such, the web sections 24 carry the rotational movement along the flexible shaft 10 while maintaining torque along that flexible shaft 10.

The pairs of slots 20 are alternately angularly oriented with respect to each other around the outer peripheral surface of the tubular body 12, that is, each succeeding pair of oppositely disposed slots 20 is rotated or displaced a predetermined angular amount from the orientation of the succeeding pair of slots 20. In the embodiment shown in FIGS. 1 and 2, that displacement or rotation is about 90 degrees such that the slots 20 are formed in the tubular body every quarter of a turn. As such, there are at least a first and second pair of oppositely disposed slots 20 formed in the tubular body 12 with, for example, the first pair having one orientation and the next or second pair of slots 20 oriented 90 degree rotated with respect to the first pair of slots 20 and so on throughout the flexible portion 18 of the tubular body 12.

While the angular displacement is illustrated in FIGS. 1 and 2 to be 90 degrees, other angular displacements may be utilized and that angular displacement need not be the same or even consistent between successive pairs of slots 20.

The width w of the slots 20 can be predetermined in accordance with the desired flexibility of the completed flexible shaft 10, that is, the larger the width dimension w, the more flexible the eventual flexible shaft 10. The same is true of the depth of the slots 20 as the oppositely disposed slots approach each other nearing the midpoint or longitudinal axis A of the tubular body 12 i.e. the smaller the thickness t of the web sections 24 between the slots of each pair, the more flexible the flexible shaft 10 becomes. In one suitable embodiment, the thickness t of the web sections 24 is about the same, dimensionally, as the width w of the slots 20.

Turning now to FIG. 3, there is shown a side cross-sectional view of the present flexible shaft taken along the line 3-3 of FIG. 2 and therefore has been rotated 90 degrees with respect to FIG. 2 orientation. As can be seen, with the 90 degree rotation, the slots 20 are now visible where there is solid material in FIG. 2 and which illustrates the embodiment of the present invention where the pairs of slots 20 are displaced angularly about 90 degrees.

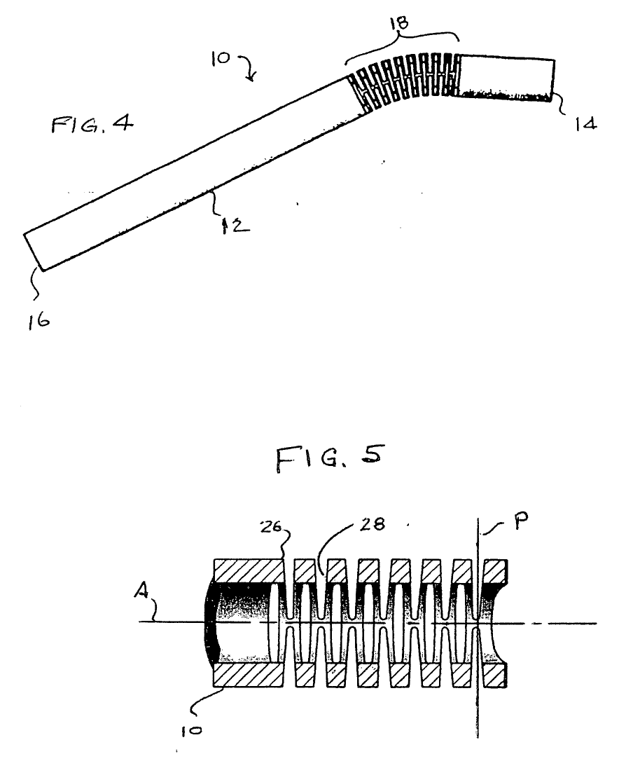

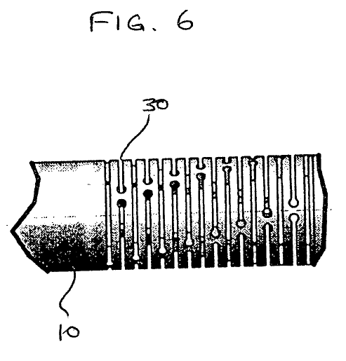

Turning now to FIG. 4, there is shown a side view of a flexible shaft 10 and illustrating the limited linear length of the flexible portion 18 to show that with any particular flexible shaft 10, the flexible portion 18 can be only a portion of the overall linear length of the flexible shaft. Thus, the designer or manufacture of the flexible shaft 10 can easily locate the flexible portion 18 at any desired location about the overall length of the flexile shaft 10 and the location and length of the flexible portion 18 can therefore be designed to provide a flexible portion into the flexible shaft 10 at any desired position along the flexible shaft 10.

As explained previously, since the flexibility of the flexible region 18 can also be manufactured to suit, depending on the aforedescribed dimensions and parameters, the degree of flexibility of the flexible portion 18 can be constructed to a desired flexibility and there may be additional flexible portions along the linear length of the flexible shaft 10 at different locations, that is, there may be a flexible portion that has a high degree of flexibility at one location along the linear length of the flexible shaft 10 and another flexible portion at another location along the same flexible shaft 10 having a stiffer flexibility.

Turning to FIG. 5, there is shown a side cross sectional view of a further alternative embodiment of the present flexible shaft. Accordingly, as contrasted to slots 20 of FIGS. 1 and 2, it can be seen that the slots 26 of the FIG. 5 embodiment, have elongated openings 28 that are still oriented to be along the plane P, however, the slots 26 taper inwardly toward the longitudinal axis A. Thus the slots can have parallel sides, taper inwardly or even be trapezoidal. Other slot configurations are therefore also within the scope of the present invention, including arcuate slots.

Turning finally to FIG. 6, there is shown a side view of the flexible shaft 10 and illustrating an embodiment of the present invention where the slots 30 are formed angularly about the periphery at angular locations different that the angles illustrated in FIGS. 2 and 3. In the FIG. 2 and 3 embodiment, the slots 20 are formed 90 degrees apart about the flexible shaft and, in the FIG. 5 embodiment, the slots 30 are at other than a 90 degree angle. As such it can be seen that the angular location of the slots about the periphery of the flexible shaft 10 can be at other than 90 degrees apart, that is, the slots can be 60 degrees apart or another angle suitable to the needs of the ultimate use of the shaft.

Those skilled in the art will readily recognize numerous adaptations and modifications which can be made to the flexible shaft and method of constructing the same of the present invention which will result in an improved flexible shaft and method, yet all of which will fall within the scope and spirit of the present invention as defined in the following claims. Accordingly, the invention is to be limited only by the following claims and their equivalents.

What is claimed is:

1. A flexible shaft comprising:
a body having external ends, a longitudinal axis and an outer peripheral surface;
a plurality of pairs of non-continuous slots oppositely disposed comprising elongated openings formed in the outer peripheral surface in a common plane, said slots extending inwardly from the elongated openings toward but not reaching the longitudinal axis of the body to form web sections between the slots of each pair of slots;
each succeeding pair of slots being spaced apart along the longitudinal axis and being angularly displaced at a predetermined angular displacement from a preceding pair of slots.

2. The flexible shaft as defined in claim 1 wherein said body is a tubular body.

3. The flexible shaft as defined in claim 2 where the common plane is orthogonal to the longitudinal axis of the tubular body.

4. The flexible shaft as defined in claim 1 where the angular displacement between successive pairs of slots is about 90 degrees.

5. The flexible shaft as defined in claim 1 wherein the pairs of slots have external ends and wherein the web sections are formed separating the external ends of each of the slots of a pair of slots.

6. The flexible shaft as defined in claim 1 wherein the slots extend linearly along a portion of the flexible shaft.

7. The flexible shaft as defined in claim 1 wherein the flexibility of the flexible shaft varies along the linear length of the flexible shaft.

8. The flexible shaft as defined in claim 7 wherein the variance in flexibility is created by a variance in the width of the successive slots along the longitudinal axis of the body.

9. The flexible shaft as defined in claim 7 wherein the variance in flexibility is created by a variance in spacing between successive pairs of slots along the longitudinal axis of the body.

10. The flexible shaft as defined in claim 1 wherein the thickness of the web sections separating a pair of slots is about equal to the width of the slots.

11. The flexible shaft as defined in claim 1 wherein each pair of slots is formed in the common plane orthogonal to the longitudinal axis of the body.

12. The flexible shaft as defined in claim 1 wherein at least one slot tapers inwardly in the direction toward the longitudinal axis of the body.

13. A method of constructing a flexible shaft, said method comprising the steps of:
providing a tubular body having a longitudinal axis, an external peripheral surface and external ends;
forming a plurality of pairs of oppositely disposed slots, the slots having elongated openings formed in the peripheral surface of the tubular body in a common plane orthogonal to the longitudinal axis of the tubular body and extending inwardly therefrom toward but not reaching the longitudinal axis of the tubular body to form web sections therebetween,
alternately spacing every other pair of slots to be at a predetermined angular displacement with respect to the preceding pair of slots.

14. The method of claim 13 wherein the step of forming a plurality of pairs of oppositely disposed slots comprises forming the pair of oppositely disposed slots having elongated openings in a common plane that is orthogonal to the longitudinal axis of the tubular body.

15. The method of claim 13 wherein the step of alternately spacing the pairs of slots comprises spacing the pairs of slots at an angular displacement of about 90 degrees.

16. The method of claim 13 wherein the step of forming first and second pairs of slots comprises the step of using electrical discharge machining.

17. The method of claim 13 wherein the step of providing a tubular body comprises providing a stainless steel tubular body.

18. The method of claim 13 wherein the step of forming the pairs of oppositely disposed slots comprises milling the slots into the tubular body.

19. The method of claim 13 wherein the step of forming the pairs of oppositely disposed slots comprises forming the pairs of slots at equal distances between successive pairs of slots along the longitudinal axis of the tubular body.

20. The method of claim 13 wherein the step of forming the pairs of oppositely disposed slots comprises forming the pairs of slots at differing distances between successive pairs of slots along the longitudinal axis of the tubular body.

21. The method of claim 13 wherein the step of forming the pairs of oppositely disposed slots comprises forming pairs of slots having differing depths extending inwardly toward the longitudinal axis.

22. The method of claim 13 wherein the step of forming the pairs of oppositely disposed slots comprises forming the pairs of slots having the same widths.
